(19) United States
(12) Patent Application Publication
(10) Pub. No.: US 2002/0032592 A1
(43) Pub. Date: Mar. 14, 2002

(54) Online meeting planning program

(76) Inventors: Steve Krasnick, South Field, MI (US); Marc Schecter, South Field, MI (US)

Correspondence Address: Ellen S. Cogen, Gifford, Krass, Groh, Sprinkle,, Anderson & Citkowski, P.C, 280 N. Old Woodward Ave., Suite 400, Birmingham, MI, 48009, US

(21) Appl. No.: 09/836,757

(22) Filed: Apr. 17, 2001

Related U.S. Application Data
(60) Provisional application No. 60/197,642, filed on Apr. 17, 2000.

(51) Int. Cl. G06F 17/60

(52) U.S. Cl. 705/8

(57) ABSTRACT

A comprehensive system and method for planning and managing meetings is provided. Preferably, the system and method are available via a communication network to permit multiple clients access to a wide variety of automated, meeting-related services, including online RFPs, registration, research, meeting creation, report generation, event planning, attendee management, marketplace services, community services, and customization. A client accesses a client interface to provide the system with information in response to a request generator. The data is collected from the client, stored in a database, and analyzed by a meeting management program, whereafter arrangements for a proposed meeting are executed according to a client's preferences.

### REFERENCE TO RELATED APPLICATIONS

This application claims priority of U.S. provisional patent application Ser. No. 60/197,642 filed Apr. 17, 2000, the entire content of which is incorporated herein by reference.

### FIELD OF THE INVENTION

The present invention relates generally to a system and method for planning and organizing meetings. More particularly, the present invention provides a fully integrated, comprehensive model for the automated planning, development, and production of meetings and events via a communications network.

### BACKGROUND OF THE INVENTION

The current art provides for meeting planning via manual processes. For example, one or more persons agree to meet, send out meeting notices via email or interoffice mail, and proceed to find a location in which to conduct the meeting. For proposed meetings comprising relatively small groups of persons, the situation may require extra effort to seek and find accommodations willing to cater to a small group. Further, the scope of a small meeting may not justify a budget for coordination services, leading to confusion and error in the planning and execution of the meeting.

Conversely, meeting planning for relatively large audiences generally requires, at a minimum, the services of a coordinator to research the meeting objective; gather information pertinent to the proposed meeting; locate premises capable of hosting the proposed meeting; schedule the conference area, hotel accommodations, speakers, and flights; notify the attendees of the arrangements; and complete a multitude of detailed tasks related to the meeting at hand.

As can be seen, the methods of the current art require intensive manual labor, protracted efforts, and cumbersome coordination activities, and thus may fall prey to human error or miscommunication. Further, the costs associated with manual planning often result in expenditures well over those budgeted for the meeting itself or for the coordination and management of the meeting.

### SUMMARY OF THE INVENTION

The present invention addresses the issues found in the current art by providing an efficient, end-to-end meeting system and method in an online format via a communications network such as the Internet. The online meeting planning program provides the necessary tools for a person coordinating the meeting (hereafter, coordinator) to develop and produce a successful event, including meetings for groups of fewer than one hundred persons.

Typically, the meeting planning program functions in a communications environment such as the Internet, wherein one or more persons desiring meeting planning services (hereafter, clients) access the meeting planning site via a web server on the World Wide Web. The site architecture associated with the meeting planning provides a globally accessible, easily navigable forum for planning, and permits private label, co-branding, and personalization for all services. Further, the site content of the meeting planning program adheres to standardized style guidelines and a considered writing approach to assure consistent tone, terminology, branding, and spelling therethrough.

Other site attributes include predetermined style considerations based on the tone of the content; for example, a brief yet friendly professional style designed to instill trust in the guidance and resources found in the site content, as well as promote the inherent time-savings and cost-savings associated with use of the site.

According to an embodiment of the present invention, a system is provided for online meeting planning for a plurality of clients. The system comprises a client interface, a database, and a meeting management module. The client interface mediates communications between one or more clients and the system itself; the meeting management module prompts for and collects data pertinent to a proposed meeting, as well as analyzes the collected data and executes arrangements for the meeting; and the database (or other storage means) houses the collected data.

The foregoing examples represent several of the embodiments of the present invention; however, other embodiments, objects, advantages, and benefits of the present invention also exist.

### BRIEF DESCRIPTION OF THE DRAWINGS

FIG. 1 is a schematic diagram of a system according to an embodiment of the present invention;

FIG. 2 is a schematic diagram of various system modules;

FIG. 3 is a flowchart for a method according to an embodiment of the present invention;

FIG. 4 is a schematic illustration of the information architecture of an embodiment according to the present invention;

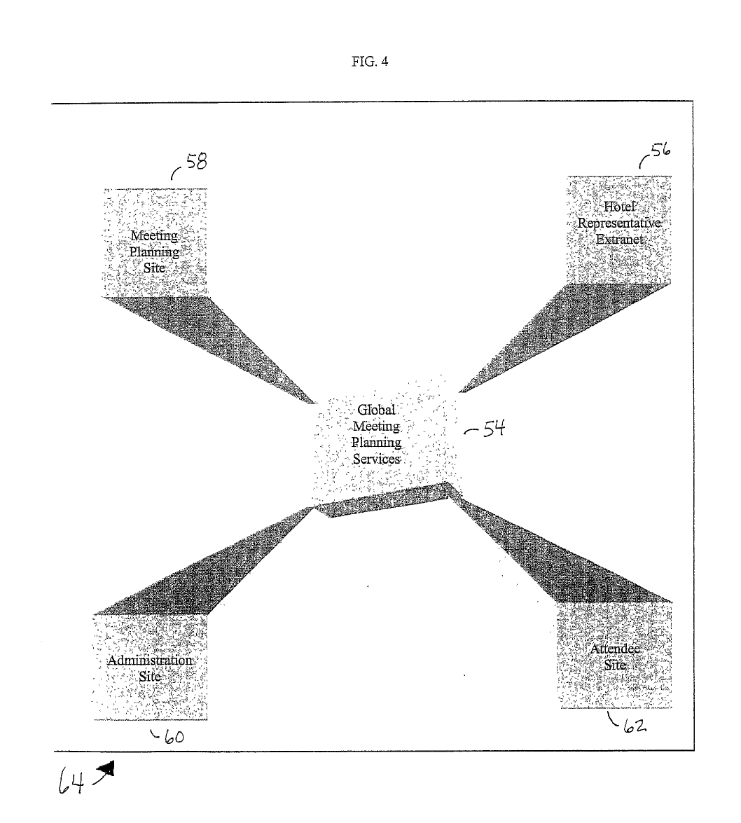

FIG. 5 is a schematic illustration of the information architecture for a hotel representative extranet;

FIG. 6 is a schematic illustration of the information architecture for a meeting planning site;

FIG. 7 is a schematic illustration of the information architecture for an administration site; and

FIG. 8 is a schematic illustration of the information architecture for an attendee site.

### DETAILED DESCRIPTION OF THE PREFERRED EMBODIMENT

In accordance with the present invention, there is provided in one embodiment, for example, a model whereby the coordinator or client uses a personal computer (PC) to access the meeting planning services via a website, containing for example, a web server, an application server, a database, and one or more Application Service Providers (ASPs).

Specifically, when the coordinator initially decides to utilize the present system to plan a meeting, the coordinator accesses the website of the meeting planning services provider, and provides specific criteria and data pertinent to the proposed meeting. The data includes, for example, the number of anticipated attendees, the date, the subject matter of the meeting, etc. The data may be provided to the system via a client interface, such as browser software on the PC in conjunction with web pages on the web server. The system collects the provided data, whereafter one or more software programs such as a meeting management module analyze it, and execute various steps to schedule a meeting or accomplish other tasks according to the criteria of the coordinator.

According to an embodiment of the present invention, some or all of the clients' data is stored in a database or similar functional structure, whereafter the data may be searched and analyzed in furtherance of multiple meeting and meeting planning objectives.

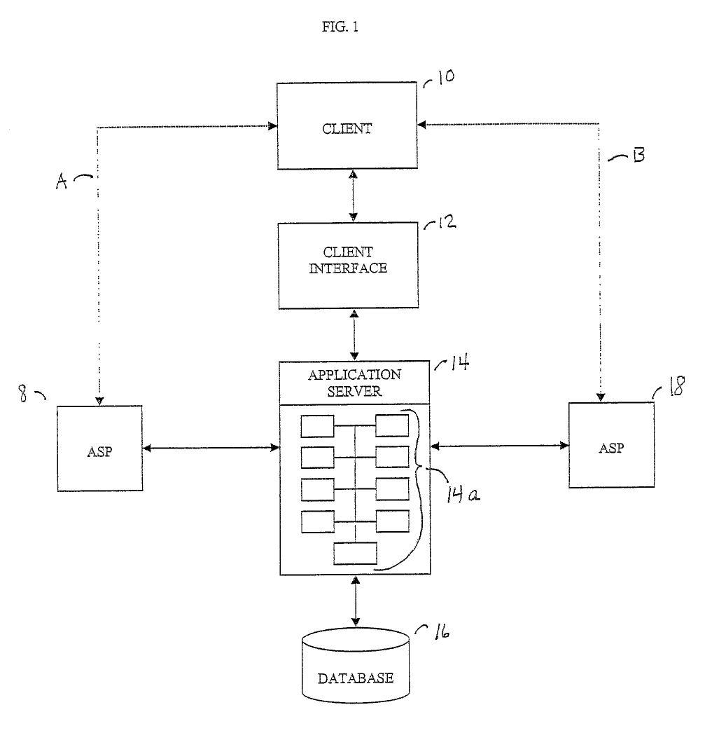

Referring now to the drawings wherein like numbers are used to denote like items throughout, FIG. 1 shows an online embodiment of the present invention utilized by a client 10, the embodiment comprising a client interface 12 implemented on a web server, a meeting management module 14 implemented on an application server, and a database 16 acting as a storage repository. Alternatively, the meeting management module software may span one or ASPs, 18 as well as the application server 14.

One or more clients 10 access the client interface 12 via one or more communication means, including wired or wireless links, computer terminals, wired, mobile, or wireless telephones, etc. The client interface 12 is typically a web server having, for example, standard Web server software such as Apache to serve static HTML communications; e.g., an HTML page with fixed content designed to remain unchanged in response to a client's request, received via browser software.

The web server architecture incorporates a scalable design having one or multiple platforms; e.g., Solaris or Microsoft. The website server includes security components such as firewalls and routers to prevent intrusion and ensure client data integrity. The website-related security components include predetermined tiered and limited access to the computer systems and components associated with the website to prevent system and data misuse.

The client interface communicates directly with a meeting management module 14 implemented on an application server. The meeting management module utilizes various categories of tools to provide various combinations of meeting planning services to clients 10. For example, the services may include registration, research, online requests for proposals, meeting management, report generation, and so forth, as discussed in detail hereafter.

The tools include third-party content providers, add-on software tools, and one or more ASPs, 18. The content providers furnish static content without any processing functionality; the add-on software tools provide site usage analysis software functionality; and the ASPs provide processing functionality via their own servers. The meeting management module communicates with the ASP servers using any common data interchange format such as XML.

In certain embodiments, the communications of the client 10 bypasses the client interface 12 to communicate directly with one or more of the ASPs, as depicted by phantom lines A and B. The communication links A and B include any topography or combination of communications, for example, wired networks and wireless communication via the electromagnetic energy spectrum. Tools may be leased, bought, or developed according to predetermined plan, or otherwise acquired.

Once the client 10 accesses the client interface 12, the client utilizes a browser or similar tool to view one or more web pages from the client interface 12. The client interface 12 communicates with the meeting management module 14 to provide the client 10 with a variety of static or dynamic content. For example, the meeting management module 14 generates a request or query for information. The meeting management module passes the request to the client interface 12 which interacts with the client's browser to display the request on the screen of the client's PC. The client 10 responds to the request by entering data via an input device such as the keyboard. The client interface 12 mediates the data flow by passing the entered data from the client's PC to the meeting management module 14 for processing or storage. In one embodiment, the meeting management module comprises, for example, one or more software programs and incorporates various components 14a to provide various meeting planning services to the client base. The meeting management module 14 cooperates with an associated storage repository such as the database 16, to store data related to clients, suppliers, and meeting plans. It is contemplated that the database 16 includes any means or structure to carry out the storage functionality of the present invention.

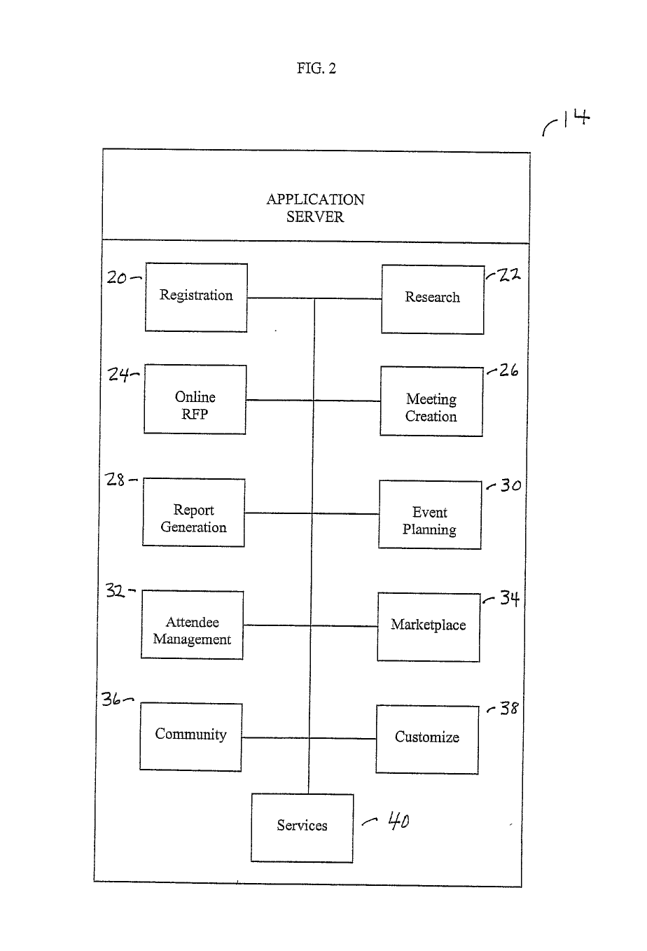

Turning now to FIG. 2, there is shown a schematic diagram of various system components. The components provide basic or additional functionality to the meeting planning system, and may exist as independent system modules, such as software programs, or may be fully integrated with one or more modules, such as the meeting management module. The components include a registration module 20; a research module 22; an online Request For Proposal (RFP) module 24; a meeting creation module 26; a report generator module 28; an event planning module 30; an attendee management module 32; a marketplace module 34; a community module 36; a customization module 38; and a services module 40.

The registration module 20 prompts for and collects client-related data, then generates a login and password based on the same. The login and password may be used to gain access to the site, create a client account, update a profile record for the client, and navigate the site to view or select areas or options of interest.

The research module 22 manages information pertaining to meeting and event products by providing search functions and relevant hyperlinks to other resources for the coordinator. The research resource tool retrieves information pertaining to, for example, vendors, meeting themes and agendas, special rate opportunities, as well as property photos and virtual tours. Scalable floor plans assist the coordinator in reserving space, while information is available to complete proposals, contracts, and obtain procurement services.

The online RFP module 24 provides the functionality for the coordinator to develop, complete, and submit an online RFP. The RFP module includes the flexibility to produce an RFP based on one or more client-supplied parameters. The parameters include financial, geographical, recreational, and theme variables. Additionally, the software tracks the status of all submitted RFPs and responses thereto, and provides access to the same.

The meeting creation module 26 delivers the functions and features necessary to plan, create, execute, and manage one or more meetings and events. Various templates for meeting planning are available for the clients' convenience.

The report generator module 28 generates a comprehensive selection of reports and information based on various input criteria. The selections include status reports, job costing and financial reports, and the like.

The event planning module 30 provides the functionality to research and plan events and activities. The events and activities may be associated with or independent of other scheduled meetings. For example, the planner utilizes the event planning module 30 to research and book a group dinner located at a restaurant in the geographical proximity of the meeting location of the group. The planning module 30 includes tools to manage specific event details such as task lists, timelines, equipment lists, and vendors.

The attendee management module 32 provides tools for the tracking, managing, and communicating with meeting attendees or other persons. The coordinator, via the site, solicits and collects information from the attendees regarding travel arrangements, participant preferences, and the like.

The marketplace module 34 provides a dynamic, interactive forum in which the coordinator locates and procures a variety of supplier products and services for upcoming events. A search function assists the coordinator in locating prospective suppliers via a variety of criteria; for example, geographical location or product category. The coordinator completes the entire online purchase transaction with the supplier via the marketplace tool, from locating a specific product to price negotiation and payment. In various embodiments, the marketplace module includes the functionality to provide an online auction forum, where the suppliers compete through a competitive bidding process to supply the coordinator with predetermined products or services.

The community module 36 provides industry or other valuable information to coordinators via interactive web tools. The tools include chat rooms, bulletin boards, and message services for the exchange, viewing, or transfer of information.

The customization module 38 enables the coordinator to personalize or customize a solution to the unique needs of the coordinator, their clients or meeting attendees. Personalized features include coordinator preferences for products, vendors, meeting locations, and the like. Customization for various events includes customized RFPs to request additional information; corporate-branded home pages; customized client interfaces for corporate clients; additional feature requirements; integration with legacy systems, migration of available historical planning information to a private, secure storage area such as a database, and customization for existing or future private arrangements between the client and the vendor.

Finally, the services module 40 streamlines client service inquiries and minimizes the number of representatives needed for the planning process. The module facilitates communications between live representatives and coordinators. In addition, the module generates focused client inquiry surveys to direct clients to an appropriate resource, and email filtering programs to route emails to proper destinations.

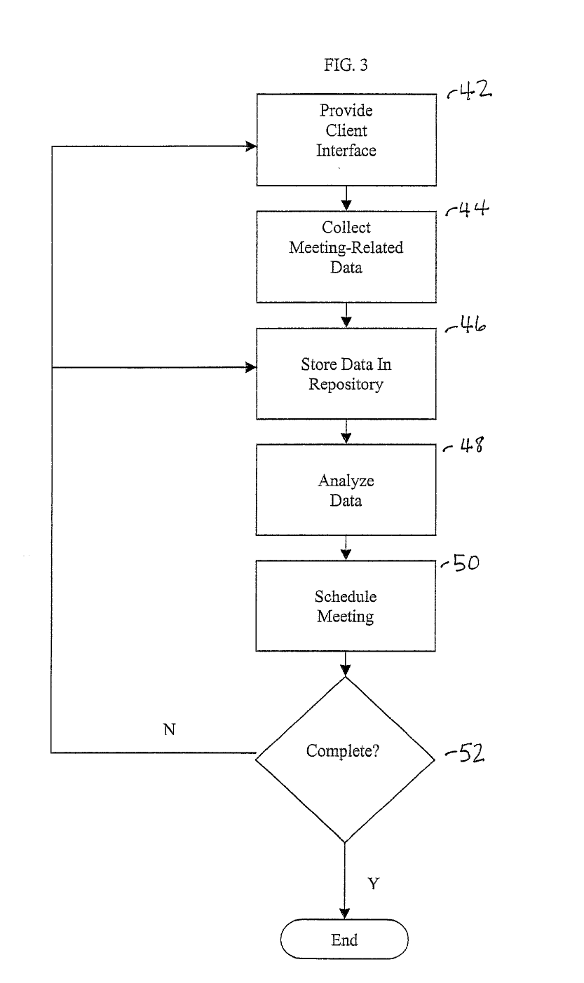

With respect to FIG. 3, there is shown a schematic depicting an embodiment of the present invention for an automated method for planning a meeting. In the method, a client is provided an interface 42. Typically, the interface contemplates a communications interface such as a website having a web server with one or more web pages, which the client accesses via a communications network such as the Internet. Upon access to the meeting planning website, data pertaining to the client or prospective client is collected 44, and stored in a repository 46. The data is analyzed 48 by one or more software programs, and the meeting is scheduled, based on the client's requirements. One or more steps of the method may be repeated 52 to achieve the desired client results.

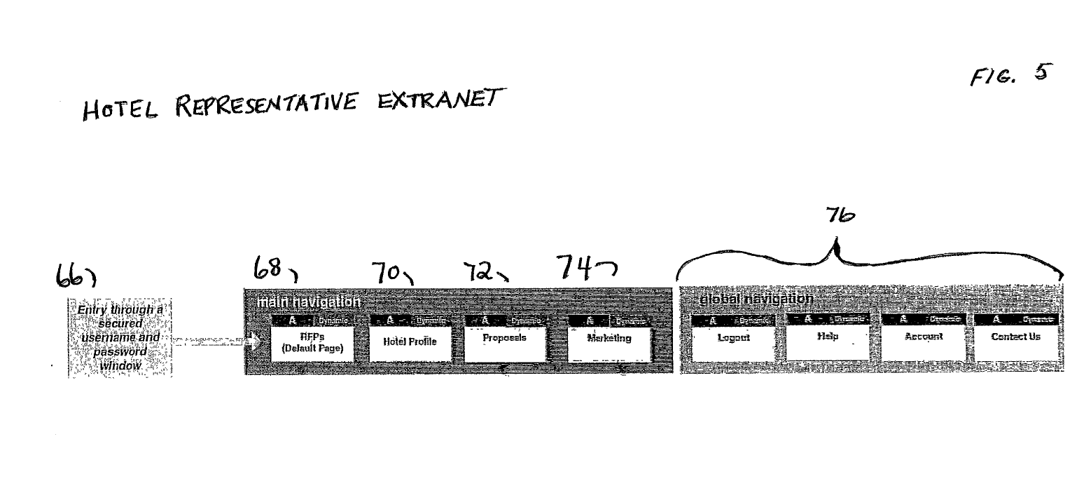

An information architecture schematic of an embodiment according to the present invention is shown in FIG. 5, wherein the entire online meeting planning invention is depicted in terms various information resources. The various information resources represent collections of information and resources, as viewed by different groups of persons visiting the meeting planning site. For example, an attendee of a meeting may be interested in locating restaurants near a meeting or verifying flight reservations, while a coordinator may need to gather information and submit an RFP. Therefore, the entire site may be viewed as comprising a collection of discrete areas of information, each area having its own architecture. The global meeting planning services site 54 houses or is associated with information for a hotel representative extranet 56, a meeting planning site 58, an administration site 60, and an attendee site 62. The sites are logical representations only, and not physical representations. As such, the site may physically reside on, for example, one server 64, or be distributed among various hardware platforms according to a predetermined plan.

Turning now to FIGS. 5-9, an example of each information architecture is shown. The hotel representative extranet information architecture may contain, as depicted in FIG. 5, information related to hotel accommodations for meeting attendees. Typically, a coordinator or hotel representative utilizes this information by providing client-specific information such as a login and password 66 to gain access to information pertinent to the respective client. The information generally includes a section on RFPs 68, where the coordinator can locate RFPs sent to the hotel; the status of each RFP, associated deadlines; and so forth. Hotel profiles 70 are also available, whereby current information about various hotel are maintained. Proposals 72 provides information about bids sent to clients; templates for responses; and the statuses of various proposals. Marketing 74 displays currently utilized marketing options. Additional marketing opportunities include banner advertisements, news, industry and trade publications, date and rate information, and surveys. Global navigation tools 76 for logout, help, account information, and contact information are also supplied.

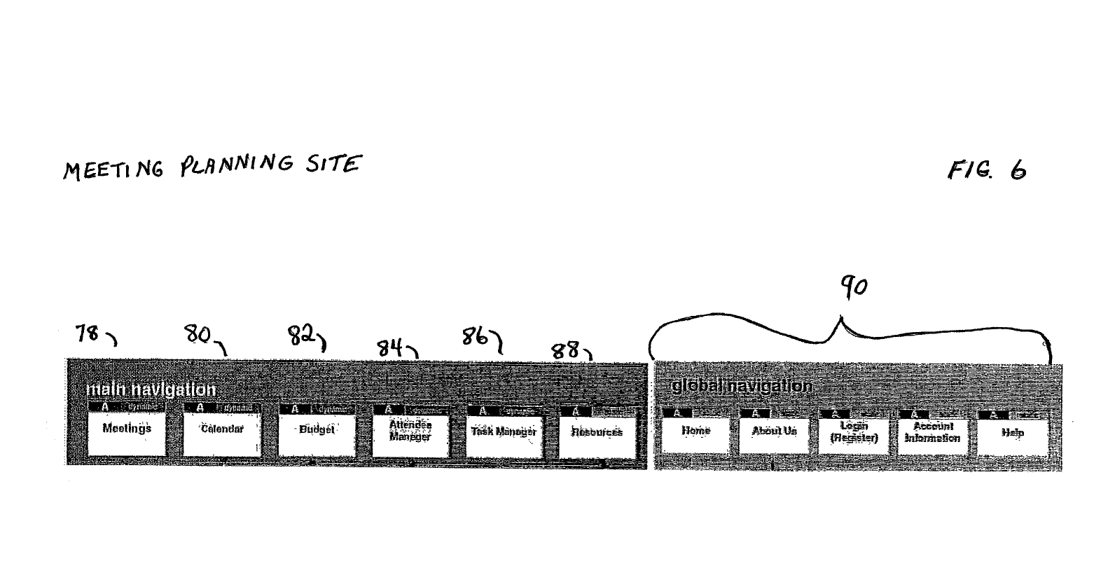

The meeting planning site information architecture, as depicted in FIG. 6, contains information for meetings 78, such as selection options to find a meeting package, as well as listing the clients' meetings currently stored on the site and statuses for the meetings. The calendar 80 contains current deadlines and other dates listed for all meetings stored on the site. The budget 82 contains selection options for predicting or constructing a budget, and actual costs as well as projected costs for various meeting components. The attendee manager 84 contains attendee information organized by meeting as well as attendee options. The task manager 86 contains a list of the major tasks needed to plan a meeting, including a meeting checklist, agenda generation, and invitation creation information. The resources 88 contain additional aids for coordinators, including features and reference information on industry news, trends, training and mentoring, and expert advice. Global navigation tools 90 for home page information, meeting planning service provider information, login, account information and help information are also available.

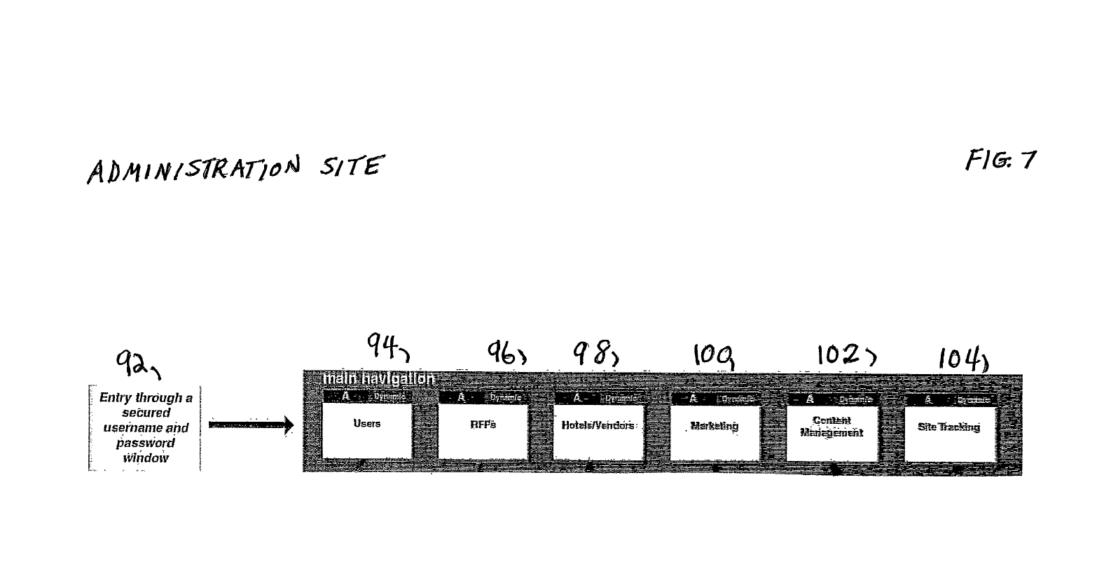

The administration site information architecture, as depicted in FIG. 7, permits administrative personnel secure access via a username and password window 92. The user area 94 contains information about the clients or users; queries the client base; and provides sorted results pertaining to individual client information, account information, meeting information, and so forth. The RFPs area 96 lists all current and past RFPs with the status of each. Contact information for the client and hotel representative is also contained in this area. The hotels/vendors area 98 contains current hotel and vendor information. Individual hotel and vendor information can be accessed to view profiles, etc. The marketing area 100 contains marketing and promotion information including ad campaigns, hotel and vendor ad campaigns, and affiliate commission tracking. The content management area 102 permits the administration to view and edit any content pieces that have been previously identified and are editable. Finally, the site tracking area 104 shows and sorts onsite activity, including emails received.

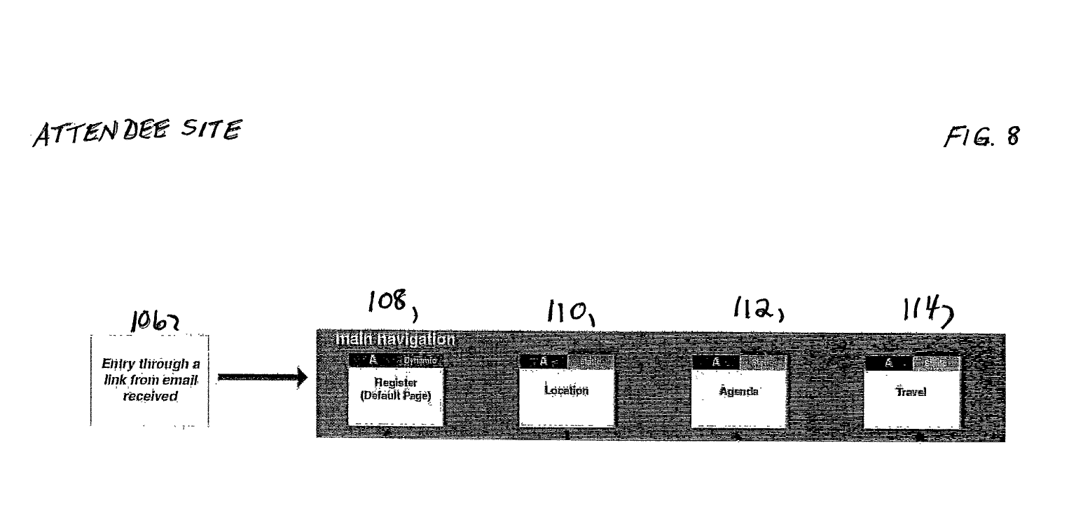

The attendee site information architecture, depicted in FIG. 8, permits meeting attendees entry through a link from email received 106. The attendees can register 108, and are prompted for all information that needs to be gathered from the attendee, including basic user information; save profile options; room preferences and room booking information; training and seminar selection; other preference options; as well as links to purchase merchandise. The location area 110 is purely informational and contains information about hotel meeting space, meeting locations, maps, weather, activities, etc. The agenda area 112 is also purely informational, containing a printable meeting agenda created by the coordinator. The travel area 114 contains information about arranging travel accommodations, including resources to air travel, rental cars, and the like.

Having illustrated and described the principles of the system and method of the present invention in various embodiments, it should be apparent to those skilled in the art that the embodiment can be modified in arrangement and detail without departing form such principles. For example, data and information entities may vary in structure, format, content, and relationship. Data entry functionality or data display functionality may be accomplished via a variety of devices, including web server, PDA, telephonic devices, or the like. Therefore, the illustrated embodiments should be considered only as examples of the invention and not as a limitation on its scope.

We claim:

1. An automated system to provide comprehensive meeting planning services for multiple clients via a communications network, the system comprising:
a client interface for mediating communications via the communication network between the client and the automated system;
a meeting management module for collecting and analyzing data pertinent to a prospective meeting; and
a database for storing the collected data.

2. The automated system of claim 1, wherein the meeting management module further comprises one or more servers.

3. The automated system of claim 1, wherein the communications network further comprises the Internet.

4. The automated system of claim 1, further comprising a research module for generation of industry and meeting information related to meeting planning.

5. The automated system of claim 1, further comprising a reporting module for report generation related to the prospective meeting.

6. The automated system of claim 1, further comprising an event module for managing events related to the prospective meeting.

7. The automated system of claim 1, further comprising an attendee module for managing logistics related to one or more meeting attendees.

8. The automated system of claim 1, further comprising a marketplace module to manage interactions between a client and a supplier.

9. The automated system of claim 1, further comprising a community module to facilitate communications between clients via the communications network.

10. The automated system of claim 1, further comprising a customization module to facilitate client preference profiles.

11. The automated system of claim 1, further comprising a service module to provide real-time communication via the communications network between the client and the meeting planning services provider.

12. An automated system for comprehensive meeting planning via the Internet for multiple clients, the automated system comprising:
a web server for mediating communications between the client and the automated system;
a request generator for collecting data pertinent to a prospective meeting;
a database for storing the collected data; and
at least one application server associated with the web server and the database, the application server having:
a meeting management module for analyzing the collected data and executing arrangements for the prospective meeting based on the analysis of the collected data;
a research module for generation of industry and meeting information related to meeting planning;
a reporting module for report generation related to the prospective meeting;
an event module for managing events related to the prospective meeting;
an attendee module for managing logistics related to one or more meeting attendees;
a marketplace module to manage interactions between a client and a supplier;
a community module to facilitate communications between clients via the communications network;
a customization module to facilitate client preference profiles; and
a service module to provide real-time communication via the communications network between the client and the meeting planning services provider.

13. The automated system of claim 12, further comprising a secure login system and secure client-specific accounts.

14. An automated method for providing comprehensive meeting planning and management services for multiple clients via a communications network, the method comprising the steps of:
providing a client interface for mediating communications via the communication network between the client and a service provider;
collecting data pertinent to a prospective meeting;
storing the collected data in a repository;
analyzing the data to determine client preferences and meeting criteria; and
scheduling the meeting according to the client preferences and the meeting criteria.

15. The automated method of claim 14, further comprising the step of establishing a client-specific account for each client.

16. The automated method of claim 14, further comprising the step of conducting online research based on client-supplied criteria and producing the results of the research.

17. The automated method of claim 14, further comprising the step of generating multiple reports.

18. The automated method of claim 14, further comprising the step of providing a project management tool to facilitate management of details related to one or more of the following group: travel arrangements, events, and activities.

19. The automated method of claim 14, further comprising the step of providing an interactive online communication tool to facilitate communications between clients.

20. The automated method of claim 14, further comprising the step of providing a transaction forum for the clients and suppliers.
